(19) United States
(12) Patent Application Publication
(10) Pub. No.: US 2002/0172636 A1
(43) Pub. Date: Nov. 21, 2002

(54) Process for the continuous production of precipitated calcium carbonate

(76) Inventors: Christoph Nover, Rheinberg (DE); Helmut Dillenburg, Rheinberg (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/093,827

(22) Filed: Mar. 11, 2002

Related U.S. Application Data
(63) Continuation of application No. PCT/EP00/08092, filed on Mar. 15, 2001.

(30) Foreign Application Priority Data
Sep. 9, 1999 (DE) 199 43 093.4

(51) Int. Cl. C01F 11/18

(52) U.S. Cl. 423/432

(57) ABSTRACT

A process for continuously producing precipitated calcium carbonate having a controllable particle diameter, in which nucleation and crystal growth are carried out in separate phases or phases. The size of the calcium carbonate particles is determined and/or controlled by the concentration of the calcium hydroxide suspension and by the ratio of CO₂ introduced to the volume of Ca(OH)₂ suspension as early as in the nucleation phase.

### CROSS REFERENCE TO RELATED APPLICATIONS

This application is a continuation of international patent application no. PCT/EP00/08092, filed Aug. 18, 2000, designating the U.S.A., the entire disclosure of which is incorporated herein by reference. Priority is claimed based on Federal Republic of Germany patent application no. DE 199 43 093.4, filed Sep. 9, 1999.

### BACKGROUND OF THE INVENTION

The invention relates to a process for the continuous production of precipitated calcium carbonate. Precipitated calcium carbonate is used for various purposes, e.g. as a filler or pigment in the papermaking or paint industries, and as a functional filler for the manufacture of plastics materials, plastisols, sealing compounds, printing inks, rubber, toothpaste, cosmetics, etc. Various processes are known for the production of precipitated calcium carbonate, with calcium hydroxide usually being used as the starting material.

According to published German patent application no. DE 196 43 657, carbon dioxide is added to a calcium hydroxide solution and the reaction mixture is passed through a continuously operating mixing reactor, in which shearing, thrust and frictional forces of intermeshing tools at high relative speed act on the reaction mixture in accordance with the rotor-stator principle. The shearing, thrust and frictional forces in the reactor cause the carbon dioxide to be introduced into the calcium hydroxide solution in an extremely finely divided form and a micronised calcium carbonate to be formed.

According to U.S. Pat. No. 2,058,503, colloidal calcium carbonate is obtained by reacting a calcium hydroxide solution in a discontinuous process with carbon dioxide at temperatures of 15 to 50° C.

U.S. Pat. No. 2,964,382 discloses a process for the production of precipitated calcium carbonate, in which the particle size is determined by the stirring speed in the reactor.

According to published European patent application no. EP 799,797, continuous production of precipitated calcium carbonate takes place in cells connected in series, the grain size and the carbonisation being influenced by the concentration of the hydrate suspension, the throughflow rate and the excess of flue gas, but more precise details of these connections and dependencies are not disclosed.

### SUMMARY OF THE INVENTION

It is an object of the present invention to provide a continuous process for the production of precipitated calcium carbonate with controllable particle diameters of 0.02 to 5 μm by reacting a suspension containing calcium hydroxide (milk of lime) with a gas containing CO₂, e.g. lime-kiln gas, flue gas or other exhaust gases from combustion operations or CO₂-containing residual gases from other processes.

According to the invention, the continuous production of precipitated calcium carbonate takes place in at least two separate stages connected in series, namely in a first stage, the nucleation stage, in which predominantly nuclei are formed, and a second stage, the crystal growth phase, in which predominantly the nuclei formed in the first stage grow. In accordance with the invention, the nucleation phase takes place in a separate reactor.

In one embodiment of the invention, the milk of lime and CO₂ are introduced into the reactor simultaneously, the quantity of CO₂ introduced being in relation to the volume of calcium hydroxide. Once nucleation has occurred, the suspension is introduced into at least one subsequent reactor, where the calcium carbonate crystals grow in the presence of CO₂.

It is likewise within the scope of the invention initially to store the reaction product temporarily after nucleation and to carry out the crystal growth phase at a later time or at a different location.

The CO₂-containing gas is introduced separately into all the stages, with good distribution of the CO₂ being ensured by known methods. Each reaction stage is adjusted separately to the respective requirement with regard to the subsequent use of the calcium carbonate, according to the desired product quality and the quality of raw materials available.

Identical or completely different reactors may be used as reaction vessels in the individual stages. In order to produce very fine particles, a very small, but thoroughly mixed reactor is advisable for stage 1 and a substantially larger, moderately mixed reactor for stage 2. Two stirred reactors of equal size may also be used for producing very large particles.

It has been discovered that the particle size of the calcium carbonate particles can be controlled depending on the concentration of the resulting calcium carbonate in the first reactor, i.e. in the nucleation phase, the residence time and the quantity of CO₂ introduced, relative to the quantity of calcium hydroxide suspension, being essential.

According to the invention, a calcium hydroxide suspension having a concentration of up to 250 grams/liter was used. The average particle diameter of the calcium hydroxide particles is 1 to 10 μm, preferably 1.2 to 5 μm. The milk of lime flows through the reactor 1 with a residence time of 0.1 sec to 3 hours.

The amount of CO₂ introduced into the first stage is 1 to 60 mole percent, preferably 5 to 50 mole percent, relative to the calcium hydroxide.

The crystal growth phase is carried out in one reactor or in reactors connected in series, the residence time possibly being 0.25 to 10 hours, preferably 1 to 3 hours, for a throughflow rate of gas containing CO₂ of at least 40 to 99 mole percent, preferably 50 to 95 mole percent, relative to the calcium hydroxide. Generally, an excess of CO₂ is introduced into stage 2 in order to ensure complete conversion.

In the first stage, the reaction of the calcium hydroxide with CO₂ is controlled such that preferably calcium carbonate nuclei are formed. Conditions which promoted nucleation with respect to crystal growth were created by varying the relative volume flows of the calcium hydroxide and the CO₂ introduced.

The concentration of resulting calcium carbonate under reaction conditions which are otherwise the same, such as calcium hydroxide and CO₂ concentration, temperature, pressure and stirring conditions in stage 1 of the process thus establishes the particle size of the final product.

The concentration of calcium carbonate in the nucleation phase is controlled by the ratio of the volume flow of CO₂ introduced relative to the volume flow of calcium hydroxide, in that in the nucleation phase

a) the calcium hydroxide volume flow for a constant reactor volume and constant CO₂ volume flow is varied, or

b) the CO₂ volume flow is varied at a constant calcium hydroxide volume flow and constant reactor volume.

### BRIEF DESCRIPTION OF THE DRAWING

FIG. 1 is intended to demonstrate the relationship between the calcium carbonate concentration in stage 1 and the resulting particle diameter after stage 2. The dependency thus illustrated applies only in connection with further reaction parameters. The course of the curve can also be displaced by varying these parameters.

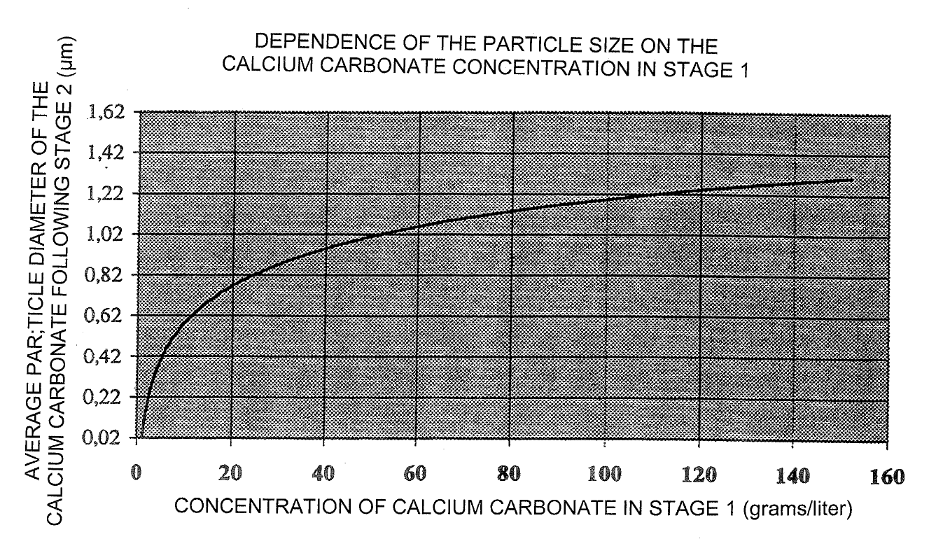

The second stage of the process takes place in a separate reactor, or in a plurality of reactors connected in series, in which the particles formed in the first stage grow.

Stage 2 can be carried out immediately following stage 1, by introducing the suspension produced in stage 1 continuously into the first reactor of stage 2. It is also possible to store the suspension produced in stage 1 temporarily or to transport it and to finish carbonisation continuously at a later time.

To carry out stage 2, the introduction of CO₂-containing gas into the reaction suspension is continued. The residence time in stage 2 must be selected such that complete conversion is ensured under the prevailing reaction conditions.

Surprisingly, it has been discovered that, in contrast to the processes known hitherto for producing precipitated calcium carbonate, the particle size of the calcium carbonate particles is determined as early as in the stage of nucleation.

The particle size is usually determined using the Blaine method, by determining the air resistance of a tablet compressed from the calcium carbonate and calculating the average particle diameter therefrom. Further conventional possibilities for determining this particle diameter are electron microscopy or the BET method.

In a preferred embodiment, the particle size is determined by laser light scattering. This method may be carried out directly on the suspension leaving stage 2. The method can be used online and be used to regulate the process by regulating the ratio of the volume flows of CO₂ and calcium hydroxide accordingly. The combination of the continuous production of calcium carbonate with this analysis method results in a constancy of the quality relative to the particle diameter which has scarcely been achieved hitherto.

The particles are generally present in agglomerated form, with the inclination to agglomeration decreasing with increasing particle diameter. Thus average agglomerate diameters of 1.7 μm are found for particle sizes of 0.2 μm.

Depending on the reaction parameters set, the modification may be purely calcitic, purely aragonitic or a mixture of both. In the case of the predominantly calcitic products, both rhombohedral and scalenohedral crystals may be precipitated. In the case of the aragonitic products, the form factor (ratio of length to diameter) may be varied within a wide range.

It has furthermore been discovered that in one embodiment of the process calcium carbonate having an aragonite structure is formed if a high degree of supersaturation relative to calcium carbonate can be achieved in stage 1. This requires a fine-particled milk of lime and metering of sufficiently large quantities of CO₂. Calcium carbonate having a controllable aragonite content of 0 to >90% aragonite can be produced.

The following examples are intended to illustrate the invention in further detail without restricting its scope.

Example 1: Production of finely precipitated calcium carbonate (CCP) with aragonitic structure for use in toothpaste

| Ca(OH)₂ concentration | 150 grams/liter |
|---|---|
| Ca(OH)₂ average particle diameter | 1.2 μm |
| CO₂ concentration | 20% by volume |
| Flow of milk of lime | 5 liters/hour |
| Stage 1 | |
| Stirrer-equipped vessel with propeller stirrer, | |
| Speed 800 rpm, volume 1.7 liters, | |
| Gas introduction through base valve | |
| Temperature | 35° C. |
| Residence time of the milk of lime in stage 1 | 20 min. |
| CO₂ flow | 150 liters/hour |
| Stage 2 | |
| Stirrer-equipped vessel with propeller stirrer, | |
| Speed 800 rpm, volume 10 liters, | |
| Gas introduction through base valve | |
| Temperature | not controlled |
| Residence time of the milk of lime in stage 2 | 2 hours |
| CO₂ flow | 600 liters/hour |
| Characterization of the end product | |
| average particle diameter | 0.22 μm |
| Modification | 98% aragonite |
| Agglomerate diameter | 1.17 μm |
| Form factor | 15 |

Example 2: Production of fine, predominantly calcitic CCP for use in paper coatings

| | |
|---|---|
| Ca(OH)₂ concentration | 150 grams/liter |
| Ca(OH)₂ average particle diameter | 2.3 μm |
| CO₂ concentration | 12% by volume |
| Flow of milk of lime | 5 liters/hour |
| Stage 1 | |
| Stirrer-equipped vessel with propeller stirrer, | |
| Speed 800 rpm, volume 2.5 liters, | |
| Gas introduction through base valve | |
| Temperature | 70° C. |
| Residence time of the milk of lime in stage 1 | 30 min. |
| CO₂ flow | 600 liters/hour |
| Stage 2 | |
| Stirrer-equipped vessel with propeller stirrer, | |
| Speed 800 rpm, volume 10 liters, | |
| Gas introduction through base valve | |
| Temperature | not controlled |
| Residence time of the milk of lime in stage 1 | 2 hours |
| CO₂ flow | 600 liters/hour |
| Characterization of the end product | |
| Average particle diameter | 0.27 μm |
| Modification | 85% calcite |
| Agglomerate diameter | 1.21 μm |
| Morphology | scalenohedron |

Example 3: Production of fine, predominantly calcitic CCP for use in paper coatings, with temporary storage of the suspension

| | |
|---|---|
| Ca(OH)₂ concentration | 150 grams/liter |
| Ca(OH)₂ average particle diameter | 2.3 μm |
| CO₂ concentration | 12% by volume |
| Flow of milk of lime | 5 liters/hour |
| Stage 1 | |
| Stirrer-equipped vessel with propeller stirrer, | |
| Speed 800 rpm, volume 2.5 liters, | |
| Gas introduction through base valve | |
| Temperature | 70° C. |
| Residence time of the milk of lime in stage 1 | 30 min. |
| CO₂ flow | 600 liters/hour |

100 liters of the suspension of stage 1 was stored for one week at room temperature and then introduced continuously into stage 2, the characterization of the end product after establishing the equilibrium of reaction taking place after approximately 15 hours.

| | |
|---|---|
| Stage 2 | |
| Stirrer-equipped vessel with propeller stirrer, | |
| Speed 800 rpm, volume 10 liters, | |
| Gas introduction through base valve | |
| Temperature | 25° C. |
| Residence time of the milk of lime in stage 1 | 2 hours |
| CO₂ flow | 600 liters/hour |
| Characterization of the end product | |
| Average particle diameter | 0.28 μm |
| Modification | 85% calcite |
| Agglomerate diameter | 1.19 μm |
| Morphology | scalenohedron |

Example 4: Production of ultrafine, predominantly calcitic CCP for use as a rheological additive in plastisols

| | |
|---|---|
| Ca(OH)₂ concentration | 150 grams/liter |
| Ca(OH)₂ average particle diameter | 1.2 μm |
| CO₂ concentration | 40% by volume |
| Flow of milk of lime | 200 liters/hour |
| Stage 1 | |
| Supraton, volume 125 ml, speed 6,500 rpm | |
| Temperature | 30° C. |
| Residence time of the milk of lime in stage 1 | approx. 1 second |
| CO₂ flow | 20 m³/hour |
| Stage 2 | |
| Stirrer-equipped vessel with 6-blade stirrer | |
| Speed 750 rpm, volume 500 liters, | |
| Gas introduction through 3 valves in the | |
| vicinity of the stirrer | |
| Temperature | not controlled |
| Residence time of the milk of lime in stage 1 | 2.5 hours |
| CO₂ flow | 25,000 liters/hour |
| Characterization of the end product | |
| Average particle diameter | 0.04 μm |
| Modification | 98% calcite |
| Agglomerate diameter | 1.72 μm |
| Morphology | rhombohedron |

Example 5: Production of a fine, predominantly calcitic CCP for use as a filler in papermaking stock

| | |
|---|---|
| Ca(OH)₂ concentration | 150 grams/liter |
| Ca(OH)₂ average particle diameter | 2.3 μm |
| CO₂ concentration | 12% by volume |
| Flow of milk of lime | 10 liters/hour |
| Stage 1 | |
| Stirrer-equipped vessel with propeller stirrer, | |
| Speed 800 rpm, volume 10 liters, | |
| Gas introduction through base valve | |
| Temperature | 70° C. |
| Residence time of the milk of lime in stage 1 | 60 minutes |
| CO₂ flow | 900 liters/hour |
| Stage 2 | |
| Stirrer-equipped vessel with propeller stirrer, | |
| Speed 800 rpm, volume 10 liters, | |
| Gas introduction through base valve | |
| Temperature | not controlled |
| Residence time of the milk of lime in stage 1 | 60 minutes |
| CO₂ flow | 900 liters/hour |
| Characterization of the end product | |
| Average particle diameter | 1.2 μm |
| Modification | 75% calcite |
| Agglomerate diameter | 1.3 μm |
| Morphology | predominantly |
| | scalenohedron |

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations falling within the scope of the appended claims and equivalents thereof.

What is claimed is:

1. A process for continuously producing precipitated calcium carbonate having a controllable particle size, comprising reacting a flow of calcium hydroxide with a flow of CO₂ in a nucleation phase in which predominantly calcium carbonate nuclei are formed and in a separate crystal growth phase in which predominantly the nuclei formed in the nucleation phase grow in accordance with the calcium hydroxide and the CO₂ availability, and controlling the particle size of the precipitated calcium carbonate through the concentration of the calcium carbonate nuclei formed in the nucleation phase, by varying the volume ratio of the CO₂ flow introduced into the calcium hydroxide flow by
a) by regulating the calcium hydroxide flow volume at a constant reactor volume and a constant CO₂ flow volume, or
b) by regulating the CO₂ flow volume at a constant calcium hydroxide flow volume and a constant reactor volume.

2. A process according to claim 1, wherein the calcium hydroxide is introduced as a suspension, the residence time of the calcium hydroxide suspension in the nucleation phase is from 0.1 second to 3 hours, and the CO₂ is introduced in an amount of from 1 to 60 mole percent relative to the calcium hydroxide.

3. A process according to claim 2, wherein the CO₂ is introduced in an amount from 5 to 50 mole percent relative to the calcium hydroxide.

4. A process according to claims 1, wherein CO₂-containing gas is introduced in the nucleation phase in an amount of from 0.5 to 250 liters of CO₂ per liter of calcium hydroxide suspension.

5. A process according to claim 1, wherein the crystal growth phase has a residence time of from 0.25 to 10 hours and CO₂-containing gas is introduced in an amount of from 40 to 99 mole percent relative to the calcium hydroxide.

6. A process according to claim 5, wherein the crystal growth phase has a residence time of from 1 to 3 hours, and CO₂-containing gas is introduced in an amount of from 50 to 96 mole percent relative to the calcium hydroxide.

7. A process according to claim 1, wherein the particle size is controlled exactly by measuring the particle size by laser light scattering and adjusting the ratio of the CO₂ and calcium hydroxide flow volumes in response to the measured particle size.
